(19) United States
(12) Patent Application Publication
(10) Pub. No.: US 2025/0286354 A1
(43) Pub. Date: Sep. 11, 2025

(54) GAS INSULATED SWITCHGEAR HIGH-SPEED EARTHING SWITCH AND GAS INSULATED SWITCHGEAR HAVING SAME

(71) Applicant: LS ELECTRIC CO., LTD., Anyang-si, Gyeonggi-do (KR)

(72) Inventor: Hyoung-Jin KIM, Anyang-si, Gyeonggi-do (KR)

(21) Appl. No.: 18/293,715

(22) PCT Filed: Sep. 30, 2022
(86) PCT No.: PCT/KR2022/014843

§ 371 Date: Jul. 26, 2024

(30) Foreign Application Priority Data
Dec. 27, 2021 (KR) 10-2021-0188242

(51) Int. Cl. H02B 13/075

(52) U.S. Cl. CPC H02B 13/075

(57) ABSTRACT

The present disclosure is directed to a high-speed earthing switch for a gas insulated switchgear comprising an enclosure, a cylinder member inside the enclosure and having ventilation holes formed in a lower portion and a cylinder hole formed in an end portion, and a piston member inserted into the cylinder member, having one end protruding outside through the cylinder hole, and moving forward and backward by receiving force from a drive unit to spray air inside the cylinder member toward a contact portion when opened, wherein a fixed plate having a first surface is disposed on a piston member and a movable plate is disposed on a second surface of the fixed plate facing an opposite direction to the cylinder hole, the earthing switch comprising an elastic support unit enabling the movable plate to be elastically pressed to be in close contact with the second surface of the fixed plate.

### TECHNICAL FIELD

The present disclosure relates to a high-speed earthing switch for a gas insulated switchgear and a gas insulated switchgear having the same, and more particularly, a high-speed earthing switch for a gas insulated switchgear that is capable of achieving a state where a movable plate is always in close contact with a fixed plate by using an elastic unit, so that the movable plate pushes a spring upward to exhaust internal pressure of a cylinder when the internal pressure of the cylinder becomes predetermined pressure or higher during a closing operation, so as to decrease speed reduction during the closing operation, while gas inside the cylinder is compressed during an opening operation at a side, which is opposite to a side thereof when closed, in the close contact state of the movable plate, and the compressed gas is ejected along a flow path of a mover, so as to quickly extinguish arc, and a gas insulated switchgear having the same.

### BACKGROUND ART

Typically, a gas insulated switchgear (GIS) is an electrical device that is installed in a circuit between a power side and a load side of an electrical power system, to protect the electrical power system and a load device by blocking current safely when the circuit is artificially open or closed under normal current conditions or when a fault current such as a ground fault or short circuit occurs on the circuit.

The gas insulated switchgear (GIS) generally includes a bushing unit that receives power from a high-voltage power source, a gas circuit breaker (CB), a disconnector switch, an earthing switch, a moving part, a control unit, etc. Here, the earthing switch is installed at a portion of a circuit and serves to manually ground (earth) a main circuit during device maintenance and inspection and to remove current remaining in a conductor during the device maintenance or inspection.

FIG. 1 illustrates an internal structure of a gas insulated switchgear according to the related art.

It is shown that a disconnector switch/earthing switch (DS/ES) 2 and high-speed earthing switches (HSES) 5, 9, and 10 are installed inside an enclosure 1. A drive unit or operating unit 3 is disposed outside the enclosure 1.

The high-speed earthing switch is largely divided into a fixed part and a moving part.

A fixed part 5 is disposed on a conductor 4 located inside the enclosure 1. The fixed part 5 includes a fixed contact 5a and a fixed contact holder 5b (see FIG. 2).

The moving part includes a movable shaft 6 that is connected to the drive unit 3 and rotates, a connector link 7 that is crank-connected to the movable shaft 6, a movable contact holder 8a and a movable contact 8b that are fixedly installed inside the enclosure 1, a mover 8c that is connected to the connector link 7 and moves forward and backward to connect or separate the movable contact 8b and the fixed contact 5a, and the like. In addition, a bus bar 9 is disposed to connect the moving part and an earth terminal 10. The bus bar 9 may connect the movable contact holder 8a and the earth terminal 10.

In this way, the high-speed earthing switch is configured by including the fixed part and the moving part that is in contact with or separated from the fixed part. The high-speed earthing switch is generally installed at a power inlet and used for discharging current on a line. The high-speed earthing switch must have electrostatic induction current switching performance, electromagnetic induction switching performance, closing capacity (E1 class twice), short-time electrical connection performance, and the like.

The performance of high-speed earthing switch according to the related art depends on opening and closing speed, and a blocking failure occurs even at high speed of the high-speed earthing switch depending on a type of insulating gas. For example, blocking in air is more likely to fail than blocking in SF6 gas.

FIGS. 2 and 3 illustrate operations of a high-speed earthing switch of a gas insulated switchgear according the related art. FIG. 2 shows an open state and FIG. 3 shows an earthed state.

In the high-speed earthing switch of the gas-insulated switchgear according to the related art, the movable shaft 6 is rotated by power transmitted from the drive unit 3, and the mover 8c connected to the movable shaft 6 moves forward and backward to connect (close) an earth circuit (bring the movable contact and the fixed contact into contact with each other) or disconnect (open) the earth circuit (separate the movable contact and the fixed contact from each other).

In the closed state, current flows to external ground sequentially via the fixed contact holder 5b, the fixed contact 5a, the mover 8c, the movable contact 8b, the movable contact holder 8a, the bus bar 9, and the earth terminal 10.

However, in the high-speed earthing switch of the gas-insulated switchgear according to the related art, an arcing time for which arc lasts increases depending on a type of insulating gas, resulting in a blocking failure.

Korean Patent Registration No. 10-2135381 discloses a blowing mechanism to quickly extinguish arc.

The Korean Patent Registration No. 10-2135381 discloses a configuration that includes an enclosure, a cylinder member that is installed inside the enclosure and has a ventilation hole formed in a lower portion along a circumferential surface, and a piston member that is inserted into the cylinder member and moves forward and backward by receiving force from a drive unit to spray air inside the cylinder member toward a contact part upon when opened.

Additionally, a fixed plate is installed in the middle of the piston member, and a moving plate is disposed on top of the fixed plate to be slidable along the piston member.

Referring to drawings of Korean Patent Registration No. 10-2135381, when a piston member 20 moves downward and is brought into contact with a fixed part 40, current remaining in a first conductor 14 flows to outside sequentially via the fixed part 40, the piston member 20, a movable contact 52, a moving part holder 51, a bus bar 46, and an earth terminal 45.

Here, the blowing mechanism includes a movable shaft 17 (in addition, a mechanism for transmitting force from the drive unit to the piston member may be applied), a piston member 20, a cylinder member 30, a fixed plate 60, and a movable plate 70.

FIG. 4 is a diagram showing an example in which the related art high-speed earthing switch is installed in a vertical direction, and FIG. 5 is a diagram showing an example in which the related art high-speed earthing switch is installed in a horizontal direction.

Referring to FIGS. 4 and 5, when the high-speed earthing switch is installed vertically or horizontally depending on a GIS layout of a substation, the movable plate 70 of the blowing mechanism included inside the switch generates a gap without being in close contact with the fixed plate 60 upon an opening operation, thereby failing to achieve performance required for arc blocking.

In other words, the movable plate 70 is not fixed and is located downward due to its own weight. Thus, there may be no performance problem in a vertical installation structure. However, when the movable plate 70 is installed horizontally or on a lower portion upwardly, an accurate operation is not performed depending on a state in which the movable plate is located.

### DISCLOSURE OF INVENTION

### Technical Problem

In order to solve the above problems, one aspect of the present disclosure is to provide a high-speed earthing switch for a gas insulated switchgear that is capable of achieving a state where a movable plate of a blowing mechanism is always in close contact with a fixed plate by using an elastic support unit, so that the movable plate pushes a spring upward to exhaust internal pressure of a cylinder when the internal pressure of the cylinder becomes predetermined pressure or higher during a closing operation, so as to decrease speed reduction during the closing operation, while gas inside the cylinder is compressed during an opening operation at a side, which is opposite to a side thereof when closed, in a close contact state of the movable plate, and the compressed gas is ejected along a flow path of a mover so as to quickly extinguish arc.

Another aspect of the present disclosure is to provide a high-speed earthing switch for a gas-insulated switchgear that is capable of providing freedom of installation without being restricted by an installation direction of the high-speed earthing switch for the gas-insulated switchgear.

The present disclosure is not limited to those aspects mentioned above and other aspects and advantages of the present disclosure that are not mentioned will be understood by the following description and more clearly understood by embodiments of the present disclosure. Additionally, it will be readily apparent that the aspects and advantages of the present disclosure can be realized by mechanisms indicated in the claims appended below and combinations thereof.

### Solution to Problem

In order to achieve the above aspects, the present disclosure provides a high-speed earthing switch for a gas-insulated switchgear.

The high-speed earthing switch for the gas insulated switchgear, which includes an enclosure, a cylinder member installed inside the enclosure and having ventilation holes formed in a lower portion thereof along a circumferential surface and a cylinder hole formed in an end portion thereof, and a piston member inserted into the cylinder member, having one end protruding outside through the cylinder hole, and moving forward and backward by receiving force from a drive unit to spray air inside the cylinder member toward a contact portion when opened, wherein a fixed plate having a first surface facing the cylinder hole is disposed on a piston member and a movable plate is disposed on a second surface of the fixed plate facing an opposite direction to the cylinder hole to be slidable along the piston member inside the cylinder member,
includes an elastic support unit disposed inside the cylinder member to enable the movable plate to be elastically pressed to be in close contact with the second surface of the fixed plate.

Here, the elastic support unit includes
a support member and an elastic spring,
the support member is formed in a ring shape and is fixed at a predetermined position on an outer circumference of the piston member spaced apart from the movable plate, and
the elastic spring is preferably disposed between the support member and the movable plate to elastically support the support member and the movable plate.

The elastic spring is
disposed to be wound around an outer circumference of the piston member.

The elastic spring is provided in plurality and disposed to surround the outer circumference of the piston member to elastically support the support member and the movable plate multiply at different positions, and
the plurality of elastic springs have different outer diameters from one another.

In addition, the elastic support part
includes fixed members and elastic springs,
each of the fixed members has one end extending from the second surface of the fixed plate by a predetermined length,
a stopping end is formed on another end of each of the fixed members, and
the elastic springs are disposed on the fixed members, respectively, to elastically support the movable plate and the stopping ends between the movable plate and the stopping ends.

The elastic support unit includes a first elastic support unit and a second elastic support unit,
the first elastic support unit
includes a support member and a first elastic spring,
the support member is formed in a ring shape and is fixed at a predetermined position on an outer circumference of the piston member spaced apart from the movable plate, and
the first elastic spring elastically supports the support member and the movable plate between the support member and the movable plate,
the second elastic support unit
includes fixed members and second elastic springs,
each of the fixed members has one end extending from the second surface of the fixed plate by a predetermined length,
a stopping end is formed on another end of each of the fixed members, and
the second elastic springs are disposed on the fixed members, respectively, to elastically support the movable plate and the stopping ends between the movable plate and the stopping ends.

According to another embodiment, the present disclosure provides a gas insulated switchgear including the aforementioned high-speed earthing switch.

### Advantageous Effects of Invention

According to the aspects, the present disclosure can achieve a state where a movable plate is always in close contact with a fixed plate by using an elastic unit. Accordingly, when internal pressure of a cylinder becomes predetermined pressure or higher during a closing operation, the movable plate pushes a spring upward to exhaust the internal pressure, so as to decrease speed reduction during the closing operation. On the other hand, gas inside the cylinder is compressed during an opening operation at a side of the cylinder, which is opposite to a side thereof when closed, in the close contact state of the movable plate, and the compressed gas is ejected along a flow path of a mover, so as to quickly extinguish arc.

In addition, the present disclosure can provide freedom of installation so as not to be restricted in an installation direction of a high-speed earthing switch of a gas insulated switchgear.

In addition to the above-described effects, specific effects of the present disclosure are described below while explaining specific details for carrying out the invention.

### BRIEF DESCRIPTION OF DRAWINGS

FIG. 1 is a view illustrating an internal structure of a gas insulated switchgear according to the related art.

FIGS. 2 and 3 are views illustrating operations of a high-speed earthing switch of a gas insulated switchgear according the related art.

FIG. 4 is a diagram illustrating an example in which the related art high-speed earthing switch is installed vertically.

FIG. 5 is a diagram illustrating an example in which the related art high-speed earthing switch is installed horizontally.

FIG. 6 is a diagram illustrating a configuration of a high-speed earthing switch in an upward installation structure according to the present disclosure.

FIG. 7 is a diagram illustrating a first example of an elastic support unit according to the present disclosure.

FIG. 8 is a diagram illustrating a configuration of a high-speed earthing switch in a horizontal installation structure according to the present disclosure.

FIG. 9 is a diagram illustrating an example in which an elastic spring is provided in plurality according to the present disclosure.

FIG. 10 is a diagram illustrating a configuration of a high-speed earthing switch, to which a second example of an elastic support unit is applied, according to the present disclosure.

FIG. 11 is a view illustrating the elastic support unit of FIG. 10.

FIG. 12 is a diagram illustrating a configuration of a high-speed earthing switch in a horizontal installation structure according to the present disclosure.

FIG. 13 is a diagram illustrating a third example of an elastic support unit according to the present disclosure.

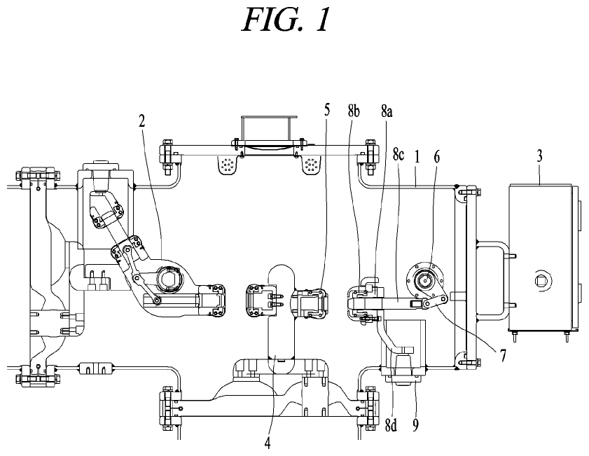

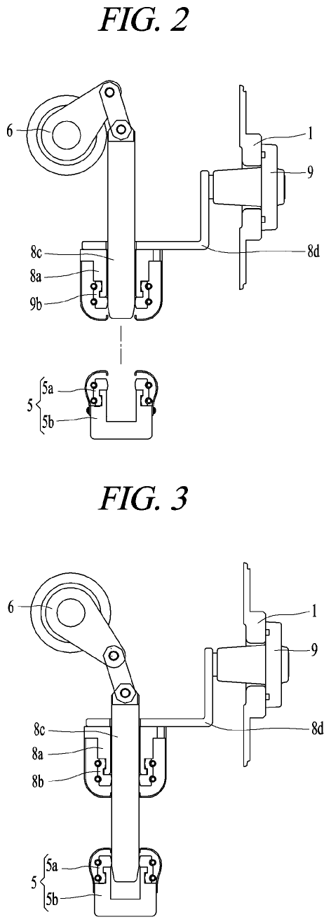

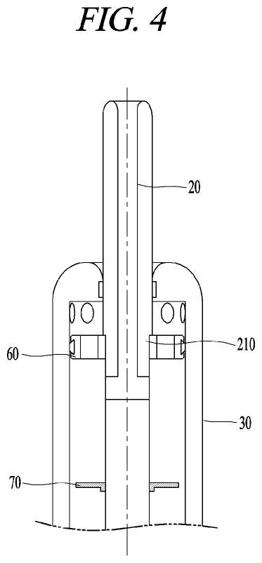

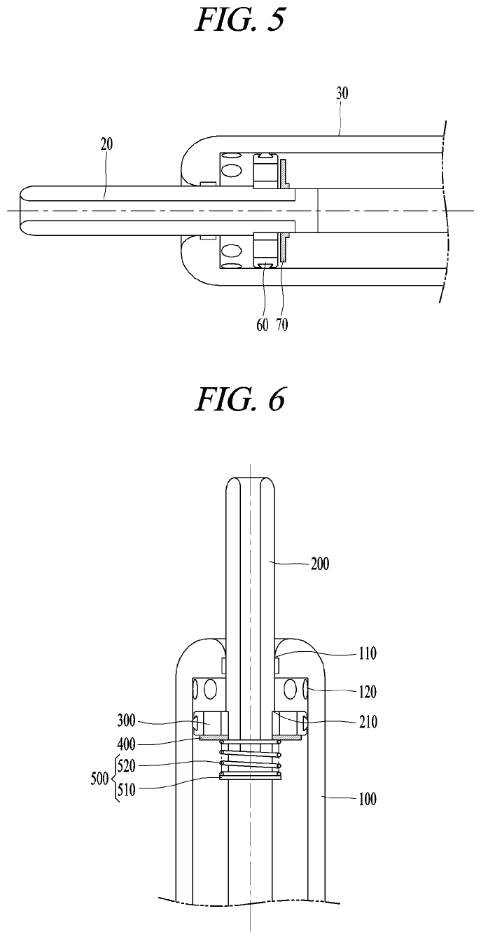

### MODE FOR THE INVENTION

The above-mentioned objects, features, and advantages will be described in detail later with reference to the attached drawings, so that those skilled in the art will be able to easily implement the technical idea of the present disclosure. In describing the present disclosure, if a detailed explanation for a related known function or construction is considered to unnecessarily divert the gist of the present disclosure, such explanation is omitted. Hereinafter, a preferred embodiment according to the present disclosure will be described with reference to the accompanying drawings. In the drawings, the same or equivalent components are provided with the same or equivalent reference numbers.

Hereinafter, it will be understood that when an element is referred to as being disposed “on an upper portion or top (or lower portion or bottom)” of another element or “on (or below)” the another element, the element can be disposed in contact with an upper surface (or lower surface) of the another element or intervening elements may also be present.

Additionally, it will be understood that when an element is described as being “connected,” “coupled,” or “accessed” to another element, the elements can be directly connected or accessed to each other, but the other element can be “interposed” between the elements or the elements can be “connected,” “coupled,” or “accessed” to each other through the other element.

Hereinafter, a high-speed earthing switch for a gas insulated switchgear and a gas insulated switchgear having the same according to the present disclosure will be described with reference to the accompanying drawings.

The gas insulated switchgear according to the present disclosure includes a high-speed earthing switch according to the present disclosure.

FIG. 6 is a diagram illustrating a configuration of a high-speed earthing switch in an upward installation structure according to the present disclosure.

Hereinafter, the configuration of the high-speed earthing switch according to the present disclosure will be described with reference to FIG. 6.

The high-speed earthing switch includes an enclosure (or outer chest) (not illustrated). A cylinder member 100 is disposed inside the enclosure. An internal space is defined in the cylinder member 100.

A cylinder hole 110 is formed at the top of the cylinder member 100. A curvature is formed on an inner circumference of an upper end of the cylinder hole 110.

Ventilation holes 120 are formed at intervals along a circumferential surface of the cylinder member 100. The ventilation holes 120 may be formed along the circumferential surface which is located below the cylinder hole 110.

A piston member 200 having a predetermined length is disposed in the cylinder member 100.

An upper end of the piston member 200 protrudes upward through the cylinder hole 110.

The piston member 200 may move forward and backward by receiving force from a drive unit (not illustrated) to spray air inside the cylinder member 100 to a contact part when opened.

A step 210 is formed at a predetermined position on the piston member 200.

A fixed plate 300 having a predetermined thickness is installed on the piston member 200. A central hole 310 is formed in a center of the fixed plate 300.

The central hole 310 of the fixed plate 300 is fitted to the piston member 200. The fixed plate 300 is fixed by being caught on the step 210.

The fixed plate 300 may alternatively be fixed to the piston member 200 in a welding manner. Also, a locking structure which includes a locking groove and a locking protrusion may be disposed between an outer circumference of the piston member 200 and an inner circumference of the central hole 310 of the fixed plate 300.

In addition, a first surface of the fixed plate 300 is disposed on a side facing the cylinder hole 110, and a second surface of the fixed plate 300 is disposed on a side facing an opposite side to the cylinder hole 110.

The outer circumference of the fixed plate 300 is disposed to slip on an inner circumference of the inner space of the cylinder member 100. A groove which is spaced apart from the inner circumference of the cylinder member 100 may be formed in an outer circumferential surface of the fixed plate 300.

A movable plate 400 having a predetermined outer diameter is disposed below the fixed plate 300.

A through hole 410 is formed through a center of the movable plate 400, and the piston member 200 is inserted through the through hole 410. Accordingly, the movable plate 400 is disposed to be slidable along the piston member.

An upper surface of the movable plate 400 is disposed to be contactable with the second surface, which is the lower surface of the fixed plate 300.

A thickness of the moving plate 400 may be thinner than a thickness of the fixed plate 300 by a predetermined value or less. Additionally, the movable plate 400 may have rigidity that is higher than that of the fixed plate 300 by a predetermined level or more.

The movable plate 400 according to the present disclosure may receive elastic force upward by an elastic support unit 500 and may be elastically pressed to be in contact with the second surface of the fixed plate 300.

The elastic support unit 500 is disposed inside the cylinder member 100.

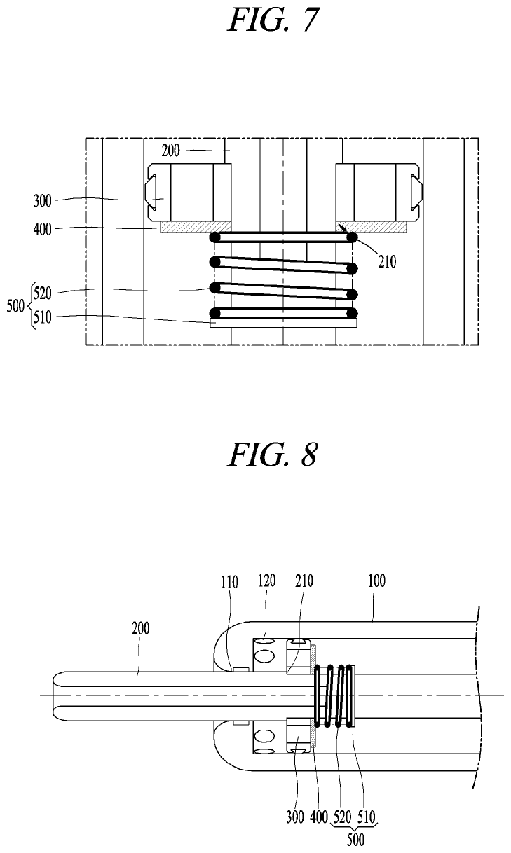

FIG. 7 is a diagram illustrating a first example of an elastic support unit according to the present disclosure.

Referring to FIG. 7, according to the first example, the elastic support unit 500 according to the present disclosure includes a support member 410 and an elastic spring 520.

The support member 510 is formed in a ring shape and is fixed at a predetermined position on the outer circumference of the piston member 200, which is spaced apart from the movable plate 400.

The elastic spring 520 may elastically support the support member 510 and the movable plate 400 between them.

The elastic spring 520 is formed in a shape wound around the outer circumference of the piston member 200.

Through this configuration, the movable plate 400 according to the present disclosure can be elastically pressed upward by elastic force of the elastic spring 520 supported on the support member 510, which is installed on the outer circumference of the piston member 200, so as to be always in close contact with the second surface of the fixed plate 300.

In the present disclosure, as the state in which the movable plate 400 is always in close contact with the fixed plate 300 is realized by using the elastic support unit 500, when internal pressure of the cylinder member 100 becomes predetermined pressure or higher during a closing operation, the movable plate 400 pushes the elastic spring 520 upward to exhaust the internal pressure, so as to decrease speed reduction during the closing operation. On the other hand, gas inside the cylinder member 100 is compressed during an opening operation at a side of the cylinder, which is opposite to a side of the cylinder when closed, and the compressed gas is ejected along a flow path of the mover, so as to quickly extinguish arc.

FIG. 8 is a diagram illustrating a configuration of a high-speed earthing switch in a horizontal installation structure according to the present disclosure.

In addition, as illustrated in FIG. 7, even when the high-speed earthing switch according to the present disclosure is installed along the horizontal direction, the movable plate 400 is always forcibly in close contact with the second surface of the fixed plate 300, so as to suppress a generation of a gap from the second surface of the fixed plate 300, thereby effectively achieving performance required for arc blocking.

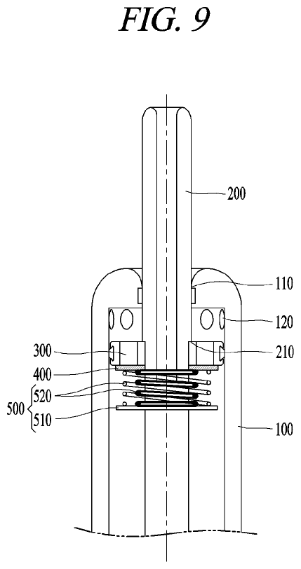

FIG. 9 is a diagram illustrating an example in which an elastic spring is provided in plurality according to the present disclosure.

Referring to FIG. 9, the elastic spring 520 according to the present disclosure may be provided in plurality, which are disposed to surround the outer circumference of the piston member 200.

The plurality of elastic springs 520 may have different outer diameters. Accordingly, the elastic springs 520 with the different outer diameters can elastically support the support member 510 and the movable plate 400 multiply at different positions.

In the movable plate 400 according to the present disclosure, by virtue of the elastic springs 520 with the different outer diameters installed at the multiple positions, even when one elastic spring decreases in elastic force, another elastic spring can apply elastic force to the movable plate 400. This may result in more efficiently suppressing a generation of a gap between the movable plate 400 and the fixed plate 300.

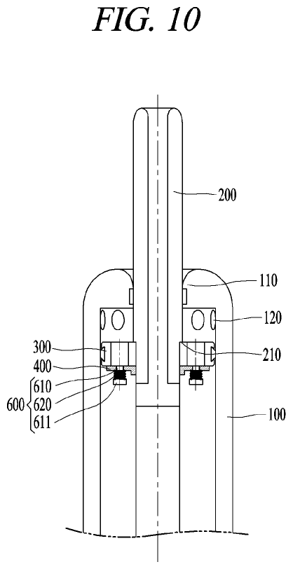

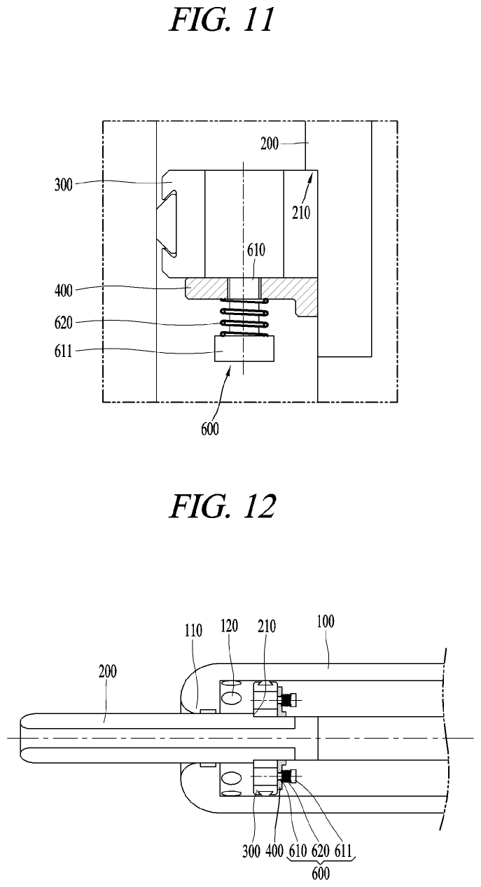

FIG. 10 is a diagram illustrating a configuration of a high-speed earthing switch, to which a second example of an elastic support unit is applied, according to the present disclosure. FIG. 11 is a view illustrating the elastic support unit of FIG. 10.

Referring to FIGS. 10 and 11, according to the second example, the elastic support unit 600 according to the present disclosure includes fixed members 610 and elastic springs 620.

One end of each of the fixed members 610 extends from the second surface of the fixed plate 400 by a predetermined length.

A stopping end 611 is formed on another end of each of the fixed members 610.

The elastic springs 620 may also be disposed on the fixed members 610, respectively, to elastically support the movable plate 400 and the stopping ends 611 between them.

Through this configuration, the moving plate 400 according to the present disclosure can be elastically pressed upward by elastic forces of the plurality of elastic springs 620, which are caught on the stopping ends 611 of the fixed members 610, respectively, so as to be in a state where it is always in close contact with the second surface of the fixed plate.

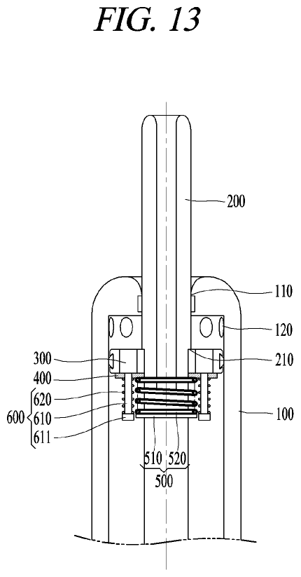

FIG. 12 is a diagram illustrating a configuration of a high-speed earthing switch in a horizontal installation structure according to the present disclosure.

In addition, as illustrated in FIG. 12, even when the high-speed earthing switch according to the present disclosure is installed along the horizontal direction, the movable plate 400 is always forcibly in close contact with the second surface of the fixed plate 300, so as to suppress a generation of a gap from the second surface of the fixed plate 300, thereby effectively achieving performance required for arc blocking.

FIG. 13 is a diagram illustrating a third example of an elastic support unit according to the present disclosure.

Referring to FIG. 13, the elastic support unit according to the third example of the present disclosure includes a first elastic support unit 500 and a second elastic support unit 600.

The first elastic support unit 500 includes a support member 510 and a first elastic spring 520.

The support member 510 is formed in a ring shape and is fixed at a predetermined position on the outer circumference of the piston member 200, which is spaced apart from the movable plate 400.

The first elastic spring 520 elastically supports the support member 510 and the movable plate 400 between them.

The second elastic support unit 600 includes fixed members 610 and second elastic springs 620.

One end of each of the fixed members 610 extends from the second surface of the fixed plate 300 by a predetermined length.

A stopping end 611 is formed on another end of each of the fixed members 610.

The second elastic springs 620 may also be disposed on the fixed members 610, respectively, to elastically support the movable plate 400 and the stopping ends 611 between them.

Through this, the movable plate 400 according to the present disclosure is elastically pressed in an upward direction by the first elastic support unit 500 through elasticity with the support member 510 installed at a predetermined position of the piston member 200.

At the same time, the movable plate 400 is elastically pressed in a downward direction by the second elastic support unit 600 through elasticity with the fixed members 610 supported on the stopping ends 611 of the fixed members 610 extending from the fixed plate 300.

Accordingly, since the movable plate 400 according to the present disclosure is elastically pressed at different positions and in different directions by the first and second elastic support units 500 and 600, the movable plate 400 can be more efficiently in contact with the second surface of the fixed plate, thereby suppressing a generation of a gap (clearance).

Here, the positions of the first and second elastic support units 500 and 600 may be disposed contrarily to the above example, based on the central axis of the piston member 200.

According to the above configuration and operation, the present disclosure can achieve a state where a movable plate is always in close contact with a fixed plate by using an elastic unit. Accordingly, when internal pressure of a cylinder becomes predetermined pressure or higher during a closing operation, the movable plate pushes a spring upward to exhaust the internal pressure, so as to decrease speed reduction during the closing operation. On the other hand, gas inside the cylinder is compressed during an opening operation at a side, which is opposite to a side thereof when closed, in the close contact state of the movable plate, and the compressed gas is ejected along a flow path of a mover, so as to quickly extinguish arc.

In addition, the present disclosure can provide freedom of installation so as not to be restricted in an installation direction of a high-speed earthing switch of a gas insulated switchgear.

The present disclosure may be subject to various substitutions, modifications, and changes by those skilled in the art, to which the present disclosure pertains, without departing from the technical idea of the present disclosure, and is not limited by the foregoing embodiment and accompanying drawings.

1. A high-speed earthing switch for a gas insulated switchgear, comprising an enclosure, a cylinder member installed inside the enclosure and having ventilation holes formed in a lower portion thereof along a circumferential surface and a cylinder hole formed in an end portion thereof, and a piston member inserted into the cylinder member, having one end protruding outside through the cylinder hole, and moving forward and backward by receiving force from a drive unit to spray air inside the cylinder member toward a contact portion when opened, wherein a fixed plate having a first surface facing the cylinder hole is disposed on a piston member and a movable plate is disposed on a second surface of the fixed plate facing an opposite direction to the cylinder hole to be slidable along the piston member inside the cylinder member, the high-speed earthing switch comprising:
an elastic support unit disposed inside the cylinder member to enable the movable plate to be elastically pressed to be in close contact with the second surface of the fixed plate.

2. The high-speed earthing switch of claim 1, wherein the elastic support unit comprises a support member and an elastic spring,
the support member is formed in a ring shape and is fixed at a predetermined position on an outer circumference of the piston member spaced apart from the movable plate, and
the elastic spring is disposed between the support member and the movable plate to elastically support the support member and the movable plate.

3. The high-speed earthing switch of claim 2, wherein the elastic spring is disposed to be wound around an outer circumference of the piston member.

4. The high-speed earthing switch of claim 2, wherein the elastic spring is provided in plurality and disposed to surround the outer circumference of the piston member, and
the plurality of elastic springs have different outer diameters from one another.

5. The high-speed earthing switch of claim 1, wherein the elastic support unit comprises fixed members and elastic springs,
each of the fixed members has one end extending from the second surface of the fixed plate by a predetermined length,
a stopping end is formed on another end of each of the fixed members, and
the elastic springs are disposed on the fixed members, respectively, to elastically support the movable plate and the stopping ends between the movable plate and the stopping ends.

6. The high-speed earthing switch of claim 1, wherein the elastic support unit includes a first elastic support unit and a second elastic support unit,
the first elastic support unit comprises a support member and a first elastic spring,
the support member is formed in a ring shape and is fixed at a predetermined position on an outer circumference of the piston member spaced apart from the movable plate,
the first elastic spring elastically supports the support member and the movable plate between the support member and the movable plate,
the second elastic support unit comprises fixed members and second elastic springs,
each of the fixed members has one end extending from the second surface of the fixed plate by a predetermined length,
a stopping end is formed on another end of each of the fixed members, and
the second elastic springs are disposed on the fixed members, respectively, to elastically support the movable plate and the stopping ends between the movable plate and the stopping ends.

7. A gas insulated switchgear comprising the high-speed earthing switch of claim 1.
